(19) United States
(12) Patent Application Publication
(10) Pub. No.: US 2026/0119145 A1
(43) Pub. Date: Apr. 30, 2026

(54) SYSTEMS AND METHODS FOR PROVIDING END-TO-END SUPPLY CHAIN SECURITY SOFTWARE ACQUISITION IN A CENTRALIZED DISTRIBUTION SYSTEM

(71) Applicant: THE BANK OF NEW YORK MELLON, New York, NY (US)

(72) Inventors: Vinay THAKER, New York, NY (US); Marc OREN, New York, NY (US)

(21) Appl. No.: 18/930,727

(22) Filed: Oct. 29, 2024

(51) Int. Cl. G06F 8/61; G06F 21/53

(52) U.S. Cl. CPC G06F 8/61; G06F 21/53

(57) ABSTRACT

Systems and methods for providing end-to-end chain security software acquisition in a centralized distribution system receive a request to install a software product in a centralized distribution system; verify that the software product has not yet been validated; quarantine the software product in a quarantine zone; validate the software product within the quarantine zone; and distribute the software product to a consumption zone when the software product passes the validation.

### CROSS-REFERENCE TO RELATED APPLICATIONS

No cross-reference is presented at this time .

### BACKGROUND

Currently, there is no standardized, industry-wide process providing for the end-to-end integrity of software as it moves from development to distribution and ultimately deployment. While concepts such as the Software Bill of Materials (SBOM) have recently emerged to help identify both primary and transitive (indirect) dependencies in software products, they are still in their infancy. SBOMs gained significant traction only after Executive Order 14028, released by the White House in 2021, which mandates the identification and transparency of software components. Despite this, SBOMs alone are insufficient to guarantee the security and integrity of the software supply chain.

A fundamental issue lies in the inherently trusting nature by which most organizations acquire software. Software is often downloaded, integrated, and deployed with minimal scrutiny or oversight, relying on ad hoc processes that vary widely across organizations and sectors. These ungoverned methods fail to account for the evolving threats posed by vulnerabilities, malware, and inadequate development practices in the components they rely on. The absence of a comprehensive, standardized vetting process for software retrieval and validation introduces certain risks. Consequently, there is a pressing need for more rigorous, formalized processes that can facilitate the integrity of software from its origin to its deployment.

### SUMMARY

Aspects of the disclosure relate to methods, apparatuses, and/or systems for providing end-to-end chain security software acquisition in a centralized distribution system.

In some aspects, the techniques described herein relate to a method, including: receiving, by a processor, a request to install a software product in a centralized distribution system; verifying, by the processor, that the software product has not yet been validated; quarantining, by the processor, the software product in a quarantine zone; validating, by the processor, the software product within the quarantine zone; and distributing, by the processor, the software product to a consumption zone when the software product passes the validation.

In some aspects, the techniques described herein relate to a method, wherein a Root of Trust (RoT) is established for the centralized distribution system; and wherein the RoT is embedded in a hardware element of the centralized distribution system.

In some aspects, the techniques described herein relate to a method, wherein validating the software product includes at least one of: testing a checksum of the software product; testing for at least one vulnerability in the software product; verifying the software bill of materials (SBOM) of the software product; validating any commits associated with the software product; or confirming terms and conditions of the software product.

In some aspects, the techniques described herein relate to a method, further including, upon validation of the software product, registering, by the processor, the software product in at least one of a software bill of materials (SBOM) registry or a software inventory.

In some aspects, the techniques described herein relate to a method, further including: receiving, by the processor, a request to access the validated software product; and enabling access to the software product based at least in part on the registration.

In some aspects, the techniques described herein relate to a method, wherein the consumption zone includes a set of policies which support the consumption of usable software within the consumption zone.

In some aspects, the techniques described herein relate to a method, wherein the set of policies include at least one of: Immutability / Locked Data, Erasure encoding, Separation of Duties, Least Privilege, Network Perimeter, Logging, Monitoring, or Resiliency.

In some aspects, the techniques described herein relate to a method, wherein, when the software product fails the validation, at least one of: rerunning the validation at least one time; maintaining the software product in the quarantine zone; or expelling the software product from the quarantine zone.

In some aspects, the techniques described herein relate to a system, including: memory storing computer program instructions; and one or more processors configured to execute the computer program instructions to: receive a request to install a software product in a centralized distribution system; verify that the software product has not yet been validated; quarantine the software product in a quarantine zone; validate the software product within the quarantine zone; and distribute the software product to a consumption zone when the software product passes the validation.

In some aspects, the techniques described herein relate to a system, wherein a Root of Trust (RoT) is established for the centralized distribution system; and wherein the RoT is embedded in a hardware element of the centralized distribution system.

In some aspects, the techniques described herein relate to a system, wherein validating the software product includes at least one of: testing a checksum of the software product; testing for at least one vulnerability in the software product; verifying the software bill of materials (SBOM) of the software product; validating any commits associated with the software product; or confirming terms and conditions of the software product.

In some aspects, the techniques described herein relate to a system, further configured to: upon validation of the software product, register the software product in at least one of a software bill of materials (SBOM) registry or a software inventory.

In some aspects, the techniques described herein relate to a system, further configured to: receive a request to access the validated software product; and enable access to the software product based at least in part on the registration.

In some aspects, the techniques described herein relate to a system, wherein the consumption zone includes a set of policies which support the consumption of usable software within the consumption zone.

In some aspects, the techniques described herein relate to a system, wherein the set of policies include at least one of: Immutability / Locked Data, Erasure encoding, Separation of Duties, Least Privilege, Network Perimeter, Logging, Monitoring, or Resiliency.

In some aspects, the techniques described herein relate to a system, wherein, when the software product fails the validation, the one or more processors are further configured to execute the computer program instructions to at least one of: rerun the validation at least one time; maintain the software product in the quarantine zone; or expel the software product from the quarantine zone.

In some aspects, the techniques described herein relate to a non-transitory computer readable medium having instructions recorded thereon, the instructions when executed by a computer having at least one programmable processor cause operations including: receiving, by the processor, a request to install a software product in a centralized distribution system; verifying, by the processor, that the software product has not yet been validated; quarantining, by the processor, the software product in a quarantine zone; validating, by the processor, the software product within the quarantine zone; and distributing, by the processor, the software product to a consumption zone when the software product passes the validation.

In some aspects, the techniques described herein relate to a non-transitory computer readable medium, wherein validating the software product includes at least one of: testing a checksum of the software product; testing for at least one vulnerability in the software product; verifying the software bill of materials (SBOM) of the software product; validating any commits associated with the software product; or confirming terms and conditions of the software product.

In some aspects, the techniques described herein relate to a non-transitory computer readable medium, further including, upon validation of the software product, registering, by the processor, the software product in at least one of a software bill of materials (SBOM) registry or a software inventory.

In some aspects, the techniques described herein relate to a non-transitory computer readable medium, further including: receiving, by the processor, a request to access the validated software product; and enabling access to the software product based at least in part on the registration.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an example software product with various primary and transitive software dependencies.

FIG. 2 depicts an illustrative system for providing validation of a software package, in accordance with at least one embodiment;

FIG. 3 depicts an example method for providing validation of a software package, in accordance with at least one embodiment; and

FIG. 4 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field of automating the provision of evaluation requests. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Embodiments provide systems and methods to securely acquire Free and Open Source Software (FOSS), Commercial off-the-shelf Software (COTS), and/or other software products and/or packages (collectively, “software”) into an organization. Many organizations require that delivery of software into the organization be from a source whose integrity can be validated. Embodiments enable the acquisition of the software and the creation of the deliverable product to be verified by an extensible pipeline, as described herein.

To establish enterprise rigor of software acquisition, embodiments of the process of acquiring new software technology described herein may provide various features, including, for example, locking down all ways an end user can physically introduce software inside the organization. At the same time, a software acquisition process may be defined and implemented to support an end user who wishes to acquire a software product, as described herein.

Embodiments described herein may strictly eliminate independent downloads of COTS and FOSS. For example, the systems and methods described herein may require that an authorized team be requested to acquire the software on behalf of the user requesting the software, which may limit users within the organization from acquiring software without governance. In some embodiments, when an end user or an application requires a certain software, the appropriate usage may be confirmed via a known method within the organization, for example, an approved ticket in a ticketing system, in which the ticket must have the appropriate approval(s) to be acted upon. In some embodiments, the approval of the ticket may be from an independent body, e.g., within the organization, to enforce segregation of duties. Furthermore, in some embodiments, the systems and methods described herein may provide tools for software lookup in a software inventory to allow for others within the organization to search and discover software products by name and/or capabilities.

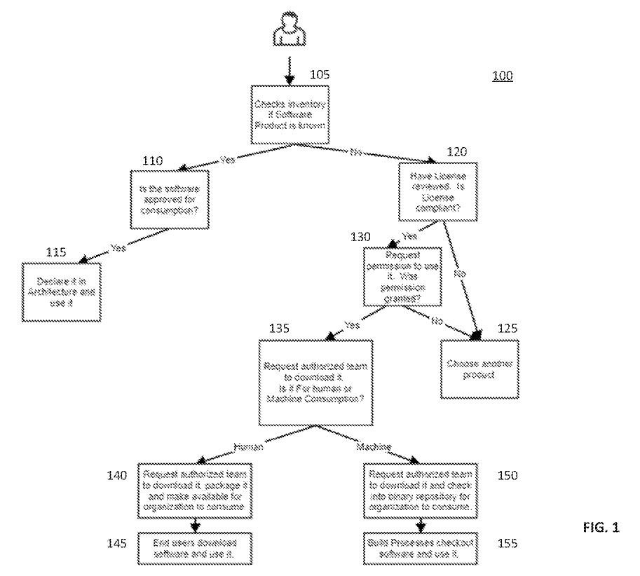

FIG. 1 shows an operational user flow 100 for acquisition of software within an organization, according to at least one embodiment. At step 105, in some embodiments, an end user (e.g., a user of software within a company or organization) desiring to install a software product may check an inventory list or registry to see if the software product is known to the organization. At step 110, if the product is known, e.g., it is approved for consumption, then at step 115 the software may be declared in architecture and used. On the other hand, if the software product is not known, then, at step 120, a first requirement is that the license be reviewed for compliance. If it is not, then at step 125 the user may be alerted that another product must be chosen, e.g., use of the product is denied. In some embodiments, as shown at step 130, a user may request permission to use the software. If permission is denied, the user may again be alerted to choose another product. However, if permission is granted, then at step 135, a request may be sent to a team or individual authorized to download or otherwise retrieve the software. As some software programs are for human consumption and some are for machine consumption, respective teams may be authorized to download software for each. Accordingly, if the software is for human consumption, then, at step 140, in some embodiments, a request to may be sent to the authorized team to download the software, package it, and make it available for users in the organization to consume, at which point, at step 145, end users may download the software for use. Likewise, if the software is for machine consumption, then, at step 150, in some embodiments, a request to may be sent to the authorized team to download the software and check it into a binary repository for systems of the organization to consume, at which point, at step 155, build processes may checkout the software and begin using it.

To implement such an operational user flow, in various embodiments, systems and methods may be provided, as described herein, which enable requested software to be downloaded, validated, and packaged into a centralized distribution system. Various embodiments of the systems and methods described herein may leverage an IT asset management system (referred to herein as “ITAM”). ITAM may enable applications to track financial, contractual, and inventory data of IT assets across their lifecycle. This combination of applications attributes enables governance of assets against an organization’s standards and risk tolerance. ITAM tracks an application and its relevant relationships, e.g., Host Inventory, Expense, Jobs, Programming Languages, etc. It is not limited to these subjects, as they represent a sample of the possible relationships ITAM may track for an application. ITAM may also track a number of attributes specific to the application, e.g., Ownership, RTO, Lifecycle, Organization Hierarchy, etc.

In some embodiments, an ITAM system may contribute to improving the security and integrity of the software supply chain by offering comprehensive visibility and control over an organization’s software assets. ITAM systems are intended to keep a detailed inventory of all software used within an organization, including licenses, versions, and dependencies, which allows for better tracking and management of software risks. This visibility helps in managing SBOMs and the various software packages with which they are associated. When vulnerabilities arise, this may help provide a rapid response in identifying and mitigating affected assets.

Additionally, ITAM systems enforce compliance and governance, so that only authorized software is acquired (e.g., downloaded) and deployed, while also providing timely updates and patching. This reduces the risk of outdated or insecure software being introduced into the organization. Through integration with vulnerability databases, ITAM systems may help organizations proactively manage risks by identifying vulnerabilities in software and prioritizing patching efforts. They also manage software licenses and version control, helping with compliance and reducing the risks associated with unsupported or unlicensed software, including software updates. Finally, the auditing and monitoring capabilities of ITAM systems provide a transparent trail of software acquisition and deployment, detecting unauthorized software and enabling adherence to governance policies. Accordingly, in some embodiments, an ITAM system may be implemented to streamline the management of software assets, making the software supply chain more secure and reducing the reliance on unstructured, ad hoc methods.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions. These and other features are described in detail herein with reference to the foregoing figures.

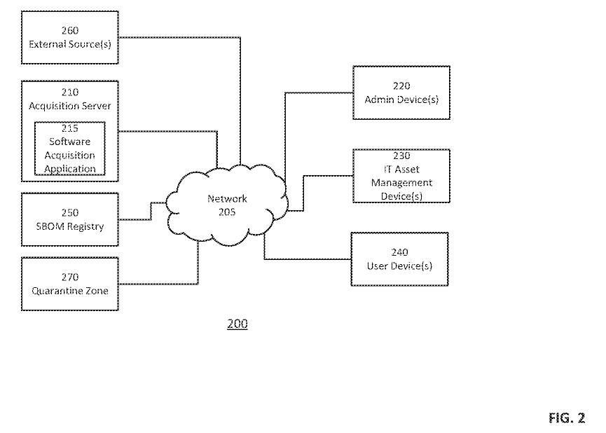

FIG. 2 depicts an illustrative system for providing end-to-end supply chain security software acquisition in a centralized distribution system, in accordance with at least one embodiment. FIG. 2 illustrates a functional block diagram of an embodiment of a software acquisition system 200 within which at least some of the disclosed techniques may be implemented. The software acquisition system 200 may be established to permit the automated or semi-automated providing of software acquisition for software packages requested to be deployed to various computing systems across network 205.

In some embodiments, various devices and applications described herein may be configured to communicate via network 205. In some embodiments, computing devices and servers described herein may communicate over network 205, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 205 may be any combination of the above, which may be a combination of private and public networks.

In some embodiments, each of the elements of software acquisition system 200 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an entity may execute a software acquisition application on a server or other computing system, e.g., acquisition server 210. Moreover, in some examples, the entity may also provide users access to an acquisition application on various user devices (e.g., devices 220, 230, and/or 240, described herein), which may be a web-based application hosted by a computing system managed by or provisioned by the entity, or which communicates with such a computing system via an application programming interface (API). Accordingly, one or more of the devices/systems/elements depicted herein may communicate with one another via messages transmitted over network 205, such as the Internet and/or various other local area networks. For example, one or more applications may communicate via messages transmitted over network 205.

In some example embodiments, acquisition server 210 may include, host, or otherwise execute a software acquisition application 215. In some embodiments, software acquisition application 215 may be a user facing application with which a user interfaces to access various aspects of the systems and methods described herein. For example, an administrator of an entity or organization may use an admin device 220 to access features of software acquisition application 215 described herein, e.g., to initiate and execute a software acquisition process, as described herein, adjust settings, etc. Likewise, various users and/or ITAM personnel may access, interact with, and/or communicate with software acquisition application 215, e.g., from ITAM devices 230 and user devices 240, respectively, as described herein. The software acquisition application 215 and users of the system (e.g., administrators, users, managers, etc.) may be isolated from accessing some or all of the features and/or information associated with the software acquisition application 215, except as described herein. For example, some users may be able to execute features of software acquisition application 215, including adjusting or modifying license and/or permission requirements, overriding rejected requests, etc., whereas others may only be able to view results.

In some embodiments, software acquisition application 215 may include a user interface through which a user may interact with software acquisition system 200 via various user devices, e.g., devices 220, 230, and 240. For example, an administrator may desire to deploy a software program in an environment for a group of users, or download the software into a binary repository for consumption by various machines within the organization. According to embodiments, the administrator, using admin device 220 may interact with a user interface of software acquisition application 215, retrieve or otherwise select the software package to be deployed, and execute software acquisition application 215 on acquisition server 210, to begin the process, as described herein. In some embodiments, an administrator may use admin device 220 to set up a scheduled execution of software acquisition application 215, e.g., weekly, monthly, etc., such as, for example, scheduled updates to various software programs.

In some example embodiments, software acquisition application 215 may be configured to coordinate with ITAM device 230 and SBOM Registry 250, to acquire (e.g., download or otherwise receive from external source(s) 260), validate, and distribute software to one or more user devices 240, e.g., of an organization. As explained above, ITAM device 230 is configured to enable applications such software acquisition application 215 to track financial, contractual, and inventory data of IT assets across their lifecycle, including during acquisition of software which is to be deployed. SBOM Registry 250, as understood herein, is a metadata repository or registry for all SBOMs to be registered and reviewed when a software package is built, as described herein. In some embodiments, when a user requests to download and install software, software acquisition application 215 may be configured to check SBOM Registry 250 to confirm whether or not the software is already registered and/or approved for downloading and/or distribution.

In some embodiments, SBOM Registry 250 may be stored or otherwise configured such that it facilitates restricted access and data integrity. For example, in some embodiments, SBOM Registry 250 may be hosted in a cloud-based or on-premise secure server, and/or may be configured with stringent access controls, e.g., employing role-based access control (RBAC) to limit who within the organization can view, modify, or manage the SBOM registry. In some embodiments, access may be restricted to key personnel such as managers, administrators, developers, security teams, compliance and other officers, and/or DevOps engineers. Such restrictions may prevent unauthorized changes or access to the list of approved software, which may negatively impact the verification processes and/or expose an organization to security risks or license violations.

In some embodiments, the repository may be hosted on a secure cloud infrastructure (e.g., AWS, Azure, or a private cloud) with encryption at rest and/or in transit to help protect the data from external threats. Alternatively, it may reside on an on-premise secure server, e.g., behind a firewall, and within an organization’s internal network, for organizations requiring higher levels of control or compliance with regulatory standards. Access to SBOM Registry 250 may be further secured through multi-factor authentication (MFA) and audit logging, so that any access or modifications are traceable. This approach protects the integrity of the SBOMs registered therein, maintaining security and compliance within the software supply chain.

In some embodiments, external sources 260 may be any external source from which a software package may be acquired, e.g., software vendors, APIs, other organizations, or even other separate systems within an organization, etc.

Finally, in some embodiments, system 200 may include or otherwise be operatively connected to a quarantine zone 270. As understood herein, a quarantine zone is a security measure which may be incorporated into a network architecture, designed to protect the core trusted network from untested or potentially harmful software or external files. This isolated part of the network may act as a buffer, such that nothing from outside the trusted environment—whether from the internet, third-party vendors, or open-source repositories—can access or interact with the core infrastructure without first being thoroughly tested and validated. In some embodiments, the quarantine zone may prevent the contamination of the trusted network by any software that could carry vulnerabilities, malware, or other security threats. By isolating this zone, an organization may minimize the risk of introducing harmful software into critical systems, maintaining a high level of security across its core operations.

In some embodiments, within quarantine zone 270, a local repository—either virtual or physical—may be provided to handle the downloading, building, and deployment of software. Isolated machines or virtual environments within this zone may be dedicated to performing these functions, such that all untrusted code or software components are run and tested in a controlled, secure environment. This repository may hold the necessary tools, libraries, and dependencies to build and test software without exposing the core network to potential risks. In some embodiments, the software may undergo rigorous validation processes, including, for example, automated security scans, code reviews, static and dynamic analysis, penetration testing, etc. Only once the software is fully vetted and deemed safe, it may be released from the quarantine zone 270 and allowed to interact with the main network, e.g., to be downloaded to user devices 240.

In some embodiments, quarantine zone 270 may take the form of a physical quarantine, which may involve isolated physical machines or entire networks that are completely air-gapped or disconnected from the core network. Physical quarantines offer a high level of isolation, as no data can cross into the core network without explicit approval, often requiring physical transfer through secure means. In some embodiments, this configuration may be ideal, e.g., for highly sensitive environments where absolute assurance is required that no untested software can enter the main infrastructure.

In other embodiments, the quarantine zone may be a virtual quarantine, such as a virtual machine (VM) or sandbox environment. These virtual quarantines may provide flexibility and scalability, allowing multiple instances of isolated environments to be created on demand. Within these virtualized spaces, software may be downloaded, tested, and built without the need for dedicated physical hardware. Virtual quarantines may be particularly useful when rapid testing is needed, as they can simulate various configurations or environments while maintaining isolation from the core network.

In some embodiments, a hybrid configuration may be employed for quarantine zone 270, combining elements of both physical and virtual quarantines. For example, an organization may use physical quarantine zones for the initial testing of software with high security requirements and then transition to virtual quarantines for ongoing testing, building, and validation. This approach may provide both the strict security of a physical quarantine and the flexibility and scalability of a virtual environment. By employing multiple layers of isolation, organizations may tailor their quarantine zone to the level of risk and the specific needs of their software supply chain, offering comprehensive protection without sacrificing efficiency or speed.

In some embodiments, access to quarantine zone 270 may be carefully controlled to facilitate the integrity and security of the environment. For example, in some embodiments, only specific individuals, such as security analysts, DevOps teams, system administrators, and compliance officers, may be granted access, since they are responsible for testing, validating, and managing the software being quarantined. Their role may involve running security assessments, building software, and facilitating compliance before any software is introduced into the core network. In some embodiments, developers may be given limited access to specific parts of the quarantine zone for testing or debugging purposes, while external vendors might receive temporary and/or monitored access to troubleshoot or validate updates. On the other hand, general employees, end users, non-security IT staff, and unauthorized contractors may not be granted access to the quarantine zone, as they do not require it for their tasks, and their involvement may pose unnecessary security risks. In some embodiments, access control mechanisms like role-based access, multi-factor authentication, and logging may be used so only authorized individuals can enter the quarantine zone, while activities may be monitored to detect any unauthorized behavior.

It should be noted that, in some embodiments, ITAM 230 may be part of or otherwise integrated with acquisition server 210 and/or software acquisition application 215, and may not be a standalone device/system. Likewise, in some embodiments, SBOM Registry 250 may be part of or otherwise integrated with acquisition server 210 and/or software acquisition application 215, and may not be a standalone device, system, and/or database. So too, in some embodiments, quarantine zone 270 may be part of or otherwise integrated with acquisition server 210 and/or software acquisition application 215, and may not be a standalone device, system, and/or database.

In some embodiments, system 200 may be a centralized distribution system having the root of its trust certified in the organization. A root of trust (RoT) is a fundamental security component that provides a reliable source of trustworthy functions for a device or system to use in establishing security. RoTs are often integrated as a chip and may be a critical component of public key infrastructures (PKIs) and symmetric key infrastructures. A silicon-based RoT is a hardware root of trust that is embedded in silicon. In some embodiments, it may be used to protect against a variety of threats, including unauthorized malware, data theft, and device hijacking. In some embodiments, the root of trust of the centralized distribution system may be embedded in silicon to help protect against the machine itself being tampered with. Likewise, in some embodiments, the root of trust may be of the strictest security protocols, so as to prevent unauthorized downloading of software to the system.

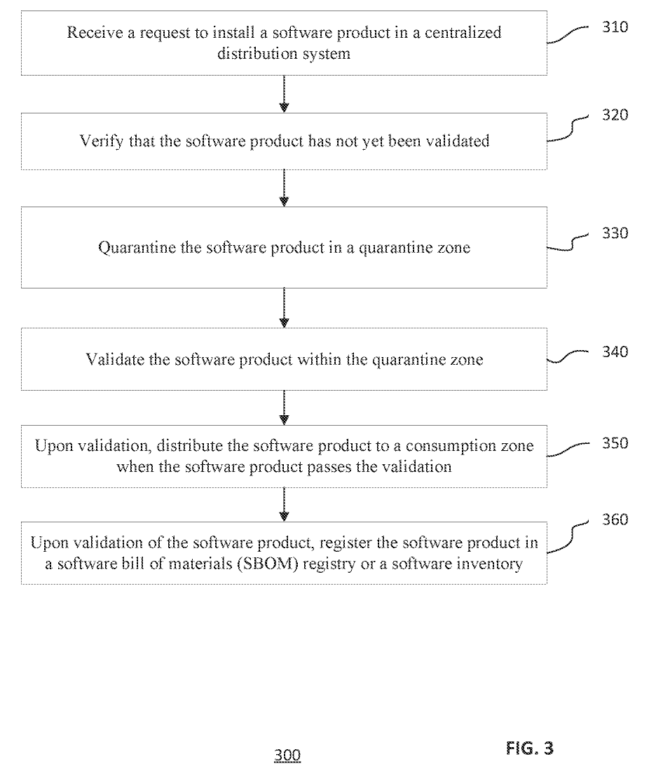

These and other features of software acquisition system 200 will be further understood with reference to the software acquisition method 300 of FIG. 3, herein.

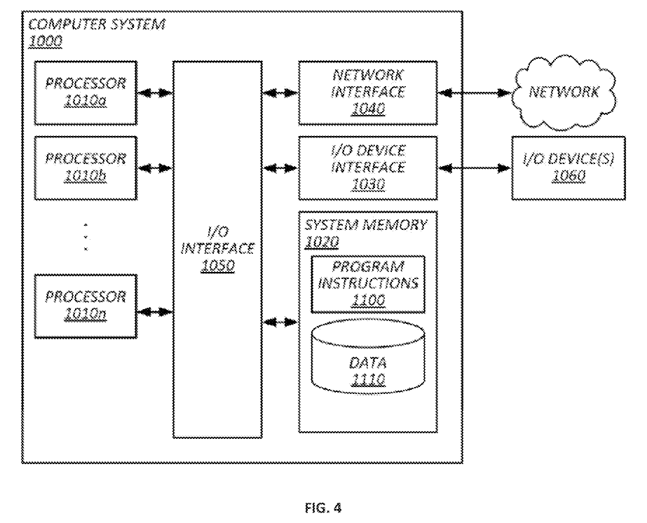

FIG. 3 depicts an example method 300 for providing end-to-end supply chain security software acquisition in a centralized distribution system, in accordance with at least one embodiment. In various embodiments, method 300 may be implemented by software acquisition system 200, executing code in one or more processors therein. For example, in some embodiments, method 300 may be performed on a computer (e.g., computer system 1000 of FIG. 4) having one or more processors (e.g., processor(s) 1010 of FIG. 4) and memory (e.g., system memory 1020 of FIG. 4), and one or more code sets, applications, programs, modules, and/or other software stored in the memory and executing in or executed by one or more of the processor(s).

Method 300 may begin at step 310 when a processor (e.g., of acquisition server 210) receives a request to install a software product in the centralized distribution system. In some embodiments, the software package may be, e.g., from a software vendor or other source, e.g., an internal software development team, etc. In some embodiments, as described in detail herein, the software package may include therein one or more, e.g., a plurality, of software products, each of which may require validation before the software may be deployed to the system.

In some embodiments, the processor may be notified of a user’s request to download software through automated detection mechanisms, such as web gateways or proxy servers. These systems may monitor download traffic and flag specific file types, such as executables or installers, automatically redirecting them to a quarantine zone, such as quarantine zone 270, for validation, as described herein. In other embodiments, users may submit manual requests through email notifications user portals, ticketing systems, etc., where the system may capture the download request and route the software to the quarantine zone for testing. Additionally, in some embodiments, endpoint detection tools may be used to trigger notifications when a download is initiated by a user. In some embodiments, these tools may send alerts to security or IT teams, or virtual artificial intelligence (AI) agents, which may then decide whether the software should be quarantined based on predefined policies, risk assessments, and/or based on prior approval.

In some embodiments, a piece of software or a software package may be retrieved from an open-source project, a vendor, a government agency, etc., or any distributor of software. In various embodiments, software may be received via a download site, e.g., via FTP or HTTP, an email, a shared storage location, a physical medium or other means of acquiring the software. Upon acquiring the software, in some embodiments, the software may be then uploaded into a binary repository from where it may be retrieved, or another secure location, e.g., directly into a quarantined zone, as described in detail herein.

At step 320, in some embodiments, the processor may be configured to verify that the software product has not yet been validated. As explained with respect to FIG. 1, when a request is received requesting to download a software product, the processor may be configured to first verify whether or not the software has already been validated. For example, the software may be one that has already been registered in at least one of a software bill of materials (SBOM) registry (e.g., SBOM Registry 250) or a software inventory.

As understood herein, a SBOM describes the internal elements or pieces of a software product. A software product may include many pieces of additional software products. Each of these software products may also be composed of additional software products. These dependent relationships are described as primary and transitive software dependencies. A SBOM is typically generated through an automated process using specialized tools that scan the software’s source code or binaries to identify all components, including libraries, dependencies, and third-party packages. These tools analyze the package manifests (e.g., package.json, pom.xml, or requirements.txt), binary files, or compiled code to extract information about the software's components. The next step typically involves dependency scanning, where the tools use package managers to gather details about each dependency, such as its version, licensing information, and any sub-dependencies. This process creates a comprehensive dependency tree of the software’s structure.

In some embodiments, once identified, the tools may collect metadata about each component, including licenses and known vulnerabilities, often referencing vulnerability databases like the National Vulnerability Database (NVD). The SBOM is then typically formatted into standard file formats, such as CycloneDX, SPDX, or SWID, so that it is machine-readable and easily shared. Many organizations integrate SBOM generation into their Continuous Integration/Continuous Delivery (CI/CD) pipelines, so it is automatically updated with each new build or dependency change. Once generated, the SBOM is typically validated, stored alongside the software artifacts, and distributed for compliance, security, and transparency purposes. Furthermore, in some embodiments, the generated SBOM may be stored in a registry, repository, or other database or list, etc., where it may be used as a lookup reference.

Accordingly, in some embodiments, e.g., when a software product is requested, the processor may be configured to check a list, e.g., an SBOM registry, such as SBOM Registry 250, or any other repository, list or database, to determine if the software being requested for download is already listed. In some embodiments, when a user initiates a download, the processor may extract key attributes of the software, such as its name, version, and unique identifiers like hash values or digital signatures. These attributes may then be used to query the SBOM registry, which contains records of previously verified software components, including their dependencies and security status.

In some embodiments, the processor may perform a direct lookup in the SBOM registry using the software’s metadata to check if the specific package or version is already registered. If a match is found, the SBOM registry may provide additional details, such as whether the software has been validated, its associated vulnerabilities, a list of its transitive dependencies, etc. This may allow the processor to decide whether the software may be downloaded without further quarantine or if it still requires additional checks.

In some embodiments, if the software is listed in the SBOM registry, the processor may enable access to the software product, e.g., based on the registration. In some embodiments, the processor may be configured to first verify whether or not the requestor is authorized to download the software, even when the software is listed.

In some embodiments, if the software is not listed in the SBOM registry, the processor may flag the download for quarantine, and/or route unlisted software to a controlled environment for testing and validation before it can enter the core network. This process may enable any software not previously vetted to undergo thorough scrutiny to mitigate potential security risks. In some embodiments, e.g., if an SBOM was acquired from an open-source project, the SBOM may be added to the SBOM registry, as described herein.

At step 330, in some embodiments, the processor may be configured to quarantine the software product in a quarantine zone. For example, in some embodiments, users may be provided a local repository, isolated machine, or other dedicated physical and/or virtual space, etc., in which the software package may be downloaded and installed, as described with respect to quarantine zone 270 (FIG. 2). In some embodiments, e.g., for machine builds, the software may be provided to a binary archive (a repository of binary files) where the software package may be built and deployed to a machine.

In some embodiments, the software may be downloaded and validated within the quarantined zone, which may be network and/or identity protected. In some embodiments, the quarantine zone may be an isolated part of the network that does not touch (e.g., is disconnected from) any of the core network. By quarantining the software, the processor is able to prevent contamination of the core trusted network with any external software that has not been tested. In some embodiments, all steps in this process may be executed in the quarantined zone prior to publishing the software to a consumption zone.

As described herein, in some embodiments, a quarantine zone may be protected at the network and/or identity levels by implementing robust security measures. For example, in various embodiments, network protection may involve segmenting the quarantine zone from the core network using firewalls, VLANs, and/or air-gapped environments to enable strict isolation, preventing unauthorized traffic from flowing in or out. Access to the quarantine zone may be further controlled using intrusion detection and prevention systems (IDS/IPS) and/or by applying strict access control lists (ACLs) to restrict communication to only trusted sources. At the identity level, protection may be enforced through strong authentication mechanisms such as, e.g., multi-factor authentication (MFA) and/or role-based access control (RBAC), so that only authorized personnel can access the zone. In some embodiments, user actions within the quarantine zone may be logged and/or monitored for accountability, and access may be limited, e.g., based on the principle of least privilege, to reduce the risk of misuse or unauthorized activity. These and other combined protections may help safeguard the quarantine zone from both external threats and insider risks.

In some embodiments, the build pipeline may be implemented within the quarantine zone, to take the software from the binary repository and run through standard build phases the organization defines, e.g., compile, build and test, etc., such that the software may be validated (or rejected), as described herein. In some embodiments, execution of the build pipeline may include generating an SBOM based on the software, and storing it to the SBOM registry, as described herein.

At step 340, in some embodiments, the processor may be configured to validate the software product within the quarantine zone. For example, in some embodiments, the processor may run one or more checks on the downloaded software, with the quarantine zone, to confirm that it meets predefined validation requirements. In various embodiments, the processor may validate quarantined software through a range of detailed tests and/or checks to confirm the software is safe and compliant before deployment in a network. One test is checksum validation, in which the processor may generate a hash value (e.g., SHA-256 or MD5) from the quarantined software and compare it against the known hash from a trusted source, such as the software vendor or a repository. This process may facilitate confirmation that the software has not been altered or tampered with during download or transmission. In some embodiments, the checksum may be automatically verified against a central repository, like a software inventory database, registry, or SBOM registry, etc., to confirm that the downloaded software matches the expected package.

In some embodiments, the processor may implement vulnerability testing, which may involve scanning the software for known security vulnerabilities. In certain embodiments, the processor may utilize vulnerability databases, such as, e.g., the National Vulnerability Database (NVD) or vendor-specific advisories, to detect any reported issues with the software or its dependencies. The processor may be configured to perform static analysis, which reviews the code without executing it, and/or dynamic analysis, where the software is executed in a controlled environment to observe its behavior and identify runtime vulnerabilities. Additionally, in some embodiments, tools such as fuzzing or penetration testing may be used to simulate attacks and discover potential weaknesses.

In some embodiments, the processor may implement testing related to an SBOM generated from the software in which the processor may, for example, examine the list of all components and dependencies that make up the software, including direct and transitive dependencies. In this embodiment, the processor may check whether each component in the SBOM is up-to-date, free of known vulnerabilities, and/or is otherwise compliant. It may also cross-reference the components against external databases to confirm that none of the included libraries or modules introduce hidden risks into the system. This may help in confirming that not only the main software but also all its underlying components are safe.

In some embodiments, the processor may be configured to validate commits, in which the system may check the development history of the software, particularly the commits that make up the software's codebase, to establish that they follow proper coding practices. In some embodiments, the processor may verify that each commit has gone through code reviews and/or automated testing, such as unit or integration tests. The system may also check that the commits adhere to version control practices and are properly signed by authorized developers, preventing unauthorized changes from being introduced into the software. The processor may further confirm that open-source software is still a managed and maintained project. Validating commits may help with certifying the integrity and reliability of the software before it is deployed.

In some embodiments, the processor may implement signature verification as another security measure. Here, the processor may check whether the software is digitally signed by the developer or vendor using a cryptographic signature. By verifying the signature against a trusted certificate authority, the processor may establish that the software originates from a legitimate source and has not been altered after signing. If the signature is invalid or missing, the system may quarantine the software for further investigation.

In some embodiments, behavioral analysis may be conducted by running the quarantined software in a sandboxed or virtual environment, isolated from the core network. The processor may observe the software’s behavior during execution, looking for any suspicious or malicious activity, such as unauthorized network connections, attempts to modify system files, or unusual resource usage. This real-time behavioral analysis may help detect malware or potentially harmful actions that may not be identified through static analysis.

In addition to security checks, in some embodiments, code linting and/or quality checks may be performed in some embodiments. The processor may be configured to evaluate the quality of the software’s code by running linting tools that check for adherence to coding standards, identifying, e.g., poor code practices, potential bugs, maintainability issues, etc. By confirming the software’s code quality, the processor may help reduce the risk of future problems stemming from poorly written or inefficient code.

In yet other embodiments, the processor may be configured to perform compliance checks, checking that the software complies with industry standards and regulatory requirements. In certain regulated industries, such as healthcare or finance, the software must meet specific compliance frameworks (e.g., HIPAA, PCI-DSS). Furthermore, various jurisdictions require adherence to certain data privacy regulations (e.g., GDPR, CCPA, etc.). The processor may automate this process by checking the software against a compliance rule set, flagging any non-compliant aspects for further review.

In some embodiments, through one or a combination of these techniques—checksum validation, vulnerability testing, SBOM analysis, commit validation, signature verification, behavioral analysis, code quality checks, and compliance reviews— and/or others, the processor in various embodiments may make certain that quarantined software is thoroughly vetted before it is deployed into the core network. These steps may help establish that the software is not only safe from vulnerabilities and malicious intent but also meets performance, quality, and/or other standards, providing a comprehensive approach to software validation within the quarantine zone. Any software that is not able to validated may be permanently quarantined and/or expunged from the system. Further, in some embodiments, the software may be added to a blacklist (for future reference). In some embodiments, a notification may be generated indicating that the software has failed the validation process and is being rejected/blocked from proceeding with distribution. Such notification may then be sent to one or more users, including admins, ITAM personnel, the user requesting the software, etc. In some embodiments, the processor may be configured to identify (e.g., based on a whitelist, other registry, or SBOM registry, etc.) any previously validated software which may provide equivalent functionality to the requested software, and generate a recommendation.

At step 350, upon validation of the quarantined software, the processor may be configured to distribute the software product to a consumption zone. For example, in some embodiments, upon validation, the processor may be configured to the compilate the downloaded software and save it from the quarantine zone into a consumption zone, along with the acquired binaries. In some embodiments, the software may be made available only to appropriately entitled users, e.g., users authorized to use the software.

As understood herein, a consumption zone in a network is a secure area where validated software may be installed and deployed for use by the organization. This zone safeguards the system such that only software that has been rigorously tested and verified is allowed for consumption, providing a controlled environment where specific policies govern the software's operation and security. In some embodiments, the consumption zone may be designed to maintain the integrity and security of the deployed software through various policies and technical measures. In some embodiments, these policies may include immutability, in which once software or data is deployed in the consumption zone, it cannot be altered without following strict processes. In some embodiments, a processor may implement immutability by locking down critical files and/or configurations using file system protections and/or version-controlled repositories, providing that any changes require authorization and/or are tracked. In some embodiments, erasure encoding may be applied to protect data in the zone by distributing encoded data across multiple storage locations, so that if any part of the data is lost or corrupted, it may be reconstructed, thereby enhancing data integrity and durability.

In some embodiments, the consumption zone may support separation of duties, which may be enforced by the processor such that no single user has complete control over the processes of installing, managing, and auditing the software. In various embodiments, different roles may be assigned to different personnel, with each role having distinct privileges, e.g., to avoid conflicts of interest and reduce the risk of insider threats. This policy may work in conjunction with least privilege, where the processor may be configured to limit the access of each user to only the minimum necessary permissions required to perform their tasks. By enforcing least privilege through role-based access control (RBAC) and/or access control lists (ACLs), the system may minimize potential attack surfaces.

In some embodiments, a network perimeter in the consumption zone may be implemented by setting up firewalls, intrusion detection systems (IDS), intrusion prevention systems (IPS), etc., to tightly control and monitor traffic entering and leaving the zone. In some embodiments, the processor may use advanced perimeter defenses like network segmentation or microsegmentation, in which different network segments are isolated from each other, and communication between them is strictly monitored and controlled. This may help confirm that only authorized traffic can reach the consumption zone, potentially reducing exposure to potential threats.

In some embodiments, logging and monitoring may be implemented to maintain security and compliance within the consumption zone. The processor may implement extensive logging to record every action, such as software installations, user access, and changes to configurations. In some embodiments, logs may be forwarded to centralized log management systems or security information and event management (SIEM) platforms for real-time analysis and alerting. Similarly, monitoring may involve continuous, scheduled, and/or targeted surveillance of system performance, user activity, and/or network traffic to detect suspicious behavior or performance anomalies. In some embodiments, the processor may employ automated monitoring tools with artificial intelligence or machine learning capabilities to identify threats more effectively by learning baseline patterns of activity.

In some embodiments, the processor may implement resiliency measures in the consumption zone. For example, in some embodiments, the processor may utilize redundant systems, fault-tolerant architectures, and/or automated failover processes, etc. This may include deploying load balancing to distribute workloads across multiple servers, so that, for example, if one component fails, another takes over seamlessly. Resiliency may help maintain the availability of software and services, even in the face of hardware failures or network disruptions.

In some embodiments, the consumption zone may be governed by a well-defined set of policies. These policies may dictate how software is installed, updated, and removed from the zone, as well as how data is managed and accessed. In some embodiments, the processor may automate policy enforcement through configuration management tools that apply and monitor compliance with organizational standards. These policies may enable the consumption zone to operate in alignment with the organization's security, compliance, and operational requirements.

In various embodiments, these and/or other policies may be implemented in the consumption zone to further enhance security and usability. For example, data encryption may be applied both in transit and at rest, such that sensitive data within the consumption zone is protected from unauthorized access. Patch management policies may be established to safeguard that all software within the zone is regularly updated with security patches to mitigate vulnerabilities. Access audit policies may also be enforced, in which the processor is configured to log all access attempts and review them regularly for any suspicious patterns, generating alerts when necessary.

In some embodiments, the consumption zone may be configured in conjunction with the validation process such that validated software may be safely deployed under a set of stringent policies. These may include any combination of immutability, erasure encoding, separation of duties, least privilege, network perimeter protection, logging, monitoring, resiliency, overall policy governance, etc. Each of these measures and/or others may be implemented by a processor in various embodiments to enable the secure and reliable operation of software within the zone, with additional policies such as encryption and patch management further bolstering the zone’s integrity.

At step 360, upon validation of the quarantined software, the processor may be further configured to register the software product in a SBOM registry and/or a software inventory. For example, in some embodiments, an SBOM generated based on the software may be registered into an SBOM registry, e.g., SBOM registry 250, to track the metadata of the attributes of the binaries, as described herein. In some embodiments, SBOM may be stored in a dedicated SBOM registry or repository, rather than being integrated into a version control system alongside the source code. Typically, SBOMs are saved in standard formats such as SPDX (Software Package Data Exchange), CycloneDX, or SWID (Software Identification Tags), and stored as a plain-text file (e.g., .json, .xml, or .spdx) within the project's root directory. However, this leaves the SBOM vulnerable to tampering or manipulation. Accordingly, in some embodiments, the generated SBOM, may be registered to a secure repository with restricted access.

In some embodiments, the processor may provide tools for software lookup in a software inventory or registry (e.g., SBOM registry 250), to allow for others within the organization to search and discover software products, e.g., by name and/or capabilities. In some embodiments, the processor may request, require, and/or confirm that each software product has a lifecycle status explaining its organizational scope. For example, a software product may be identified as: (1) approved for widespread use within the organization; (2) approved but limited to a certain set of users or applications; (3) contained from further growth but allowed to continue within its current use case; (4) sunset from current usage and set to be replaced in an agreed timeline; or (5) rejected from any use within the organization.

Embodiments described herein may enable secure acquisition of software into an organization’s network without immediately exposing the software to the network. Downloaded software may be compiled and subjected to a validation process within a quarantined zone, and either validated or rejected. Furthermore, upon deployment of validated software, the deployed software may subjected to various policies and controls within a consumption zone, further protecting the network, as described herein. Embodiment of the systems and methods described herein provide a unique process which establishes rigor, centralized control, and organizational discipline in the software acquisition process.

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term "medium," the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or "a element" includes a combination of two or more elements, notwithstanding use of other terms and phrases for one or more elements, such as “one or more.” The term "or" is, unless indicated otherwise, non-exclusive, i.e., encompassing both "and" and "or." Terms describing conditional relationships, e.g., "in response to X, Y," "upon X, Y,", “if X, Y,” "when X, Y," and the like, encompass causal relationships in which the antecedent is a necessary causal condition, the antecedent is a sufficient causal condition, or the antecedent is a contributory causal condition of the consequent, e.g., "state X occurs upon condition Y obtaining" is generic to "X occurs solely upon Y" and "X occurs upon Y and Z." Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X’ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like "parallel," "perpendicular/orthogonal," “square”, “cylindrical,” and the like, should be construed as encompassing items that substantially embody the properties of the geometric construct, e.g., reference to "parallel" surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms "first", "second", "third," “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, by a processor, a request to install a software product in a centralized distribution system;
verifying, by the processor, that the software product has not yet been validated;
quarantining, by the processor, the software product in a quarantine zone;
validating, by the processor, the software product within the quarantine zone; and
distributing, by the processor, the software product to a consumption zone when the software product passes the validation.

2. The method as in claim 1, wherein a Root of Trust (RoT) is established for the centralized distribution system; and
wherein the RoT is embedded in a hardware element of the centralized distribution system.

3. The method as in claim 1, wherein validating the software product comprises at least one of:
testing a checksum of the software product;
testing for at least one vulnerability in the software product;
verifying the software bill of materials (SBOM) of the software product;
validating any commits associated with the software product; or
confirming terms and conditions of the software product.

4. The method as in claim 1, further comprising, upon validation of the software product, registering, by the processor, the software product in at least one of a software bill of materials (SBOM) registry or a software inventory.

5. The method as in claim 4, further comprising:
receiving, by the processor, a request to access the validated software product; and
enabling access to the software product based at least in part on the registration.

6. The method as in claim 1, wherein the consumption zone comprises a set of policies which support the consumption of usable software within the consumption zone.

7. The method as in claim 6, wherein the set of policies comprise at least one of: Immutability / Locked Data, Erasure encoding, Separation of Duties, Least Privilege, Network Perimeter, Logging, Monitoring, or Resiliency.

8. The method as in claim 1, wherein, when the software product fails the validation, at least one of:
rerunning the validation at least one time;
maintaining the software product in the quarantine zone; or
expelling the software product from the quarantine zone.

9. A system, comprising:
memory storing computer program instructions; and
one or more processors configured to execute the computer program instructions to:
receive a request to install a software product in a centralized distribution system;
verify that the software product has not yet been validated;
quarantine the software product in a quarantine zone;
validate the software product within the quarantine zone; and
distribute the software product to a consumption zone when the software product passes the validation.

10. The system as in claim 9, wherein a Root of Trust (RoT) is established for the centralized distribution system; and
wherein the RoT is embedded in a hardware element of the centralized distribution system.

11. The system as in claim 9, wherein validating the software product comprises at least one of:
testing a checksum of the software product;
testing for at least one vulnerability in the software product;
verifying the software bill of materials (SBOM) of the software product;
validating any commits associated with the software product; or
confirming terms and conditions of the software product.

12. The system as in claim 9, further configured to: upon validation of the software product, register the software product in at least one of a software bill of materials (SBOM) registry or a software inventory.

13. The system as in claim 12, further configured to:
receive a request to access the validated software product; and
enable access to the software product based at least in part on the registration.

14. The system as in claim 9, wherein the consumption zone comprises a set of policies which support the consumption of usable software within the consumption zone.

15. The system as in claim 14, wherein the set of policies comprise at least one of: Immutability / Locked Data, Erasure encoding, Separation of Duties, Least Privilege, Network Perimeter, Logging, Monitoring, or Resiliency.

16. The system as in claim 9, wherein, when the software product fails the validation, the one or more processors are further configured to execute the computer program instructions to at least one of:
rerun the validation at least one time;
maintain the software product in the quarantine zone; or
expel the software product from the quarantine zone.

17. A non-transitory computer readable medium having instructions recorded thereon, the instructions when executed by a computer having at least one programmable processor cause operations comprising:
receiving, by the processor, a request to install a software product in a centralized distribution system;
verifying, by the processor, that the software product has not yet been validated;
quarantining, by the processor, the software product in a quarantine zone;
validating, by the processor, the software product within the quarantine zone; and
distributing, by the processor, the software product to a consumption zone when the software product passes the validation.

18. The non-transitory computer readable medium as in claim 17, wherein validating the software product comprises at least one of:
testing a checksum of the software product;
testing for at least one vulnerability in the software product;
verifying the software bill of materials (SBOM) of the software product;
validating any commits associated with the software product; or
confirming terms and conditions of the software product.

19. The non-transitory computer readable medium as in claim 17, further comprising, upon validation of the software product, registering, by the processor, the software product in at least one of a software bill of materials (SBOM) registry or a software inventory.

20. The non-transitory computer readable medium as in claim 19, further comprising:
receiving, by the processor, a request to access the validated software product; and
enabling access to the software product based at least in part on the registration.
